(19) United States
(12) Patent Application Publication
(10) Pub. No.: US 2008/0281772 A2
(43) Pub. Date: Nov. 13, 2008

(54) SYSTEM AND METHOD FOR MANAGING ACCESS TO STORAGE MEDIA

(75) Inventor: Michael Burtscher, Longmont, CO (US)

Correspondence Address: COOLEY GODWARD KRONISH LLP;ATTN: PATENT GROUP, Suite 1100, 777 - 6th Street, NW, WASHINGTON, DC, 20001, UNITED STATES, 703-456-8000, 202-842-7899

(73) Assignee: Webroot Software, Inc., Boulder, CO (US)

(21) Appl. No.: 11/290,200

(22) Filed: Nov. 30, 2005

(51) Int. Cl. G06F 17/30

(52) U.S. Cl. 707/1

(57) ABSTRACT

Systems and methods for managing access to a file storage device are described. One embodiment is configured to initially allow an anti-pestware process to access the file storage device, and then in response to identifying a process, other than the anti-pestware process, attempting to access the file storage device while the anti-pestware process is accessing the storage device, ceasing to allow the anti-pestware process to access the storage device during an interrupt period. In this embodiment, the interrupt period is limited so as to allow the anti-pestware process to access the storage device of the computer even if the at least one process continues to attempt to access the storage device. In variations, the interrupt period is extended one or more times in response to one or more processes other than the anti-pestware process attempting to access the file storage device.

### RELATED APPLICATIONS

The present application is related to the following commonly owned and assigned applications: application no. (unassigned), Attorney Docket No. WEBR-002/00US, entitled System and Method for Monitoring Network Communications for Pestware; application no. (unassigned), Attorney Docket No. WEBR-003/00US, entitled System and Method For Heuristic Analysis to Identify Pestware, application no. (unassigned), Attorney Docket No. WEBR-005/00US, entitled System and Method for Pestware Detection and Removal, and application no. (unassigned), Attorney Docket No. WEBR-011/00US, filed herewith, entitled System and Method for Directly Accessing Data From a Data Storage Medium each of which is incorporated by reference in their entirety.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to computer system management. In particular, but not by way of limitation, the present invention relates to systems and methods for controlling pestware or malware.

### BACKGROUND OF THE INVENTION

Personal computers and business computers are continually attacked by trojans, spyware, and adware, collectively referred to as “malware” or “pestware.” These types of programs generally act to gather information about a person or organization—often without the person or organization's knowledge. Some pestware is highly malicious. Other pestware is non-malicious but may cause issues with privacy or system performance. And yet other pestware is actual beneficial or wanted by the user. Wanted pestware is sometimes not characterized as “pestware” or “spyware.” But, unless specified otherwise, “pestware” as used herein refers to any program that collects and/or reports information about a person or an organization and any “watcher processes” related to the pestware.

Software is available to detect pestware, but scanning a system for pestware typically requires a system to look at files stored in a data storage medium (e.g., disk) on a file by file basis. While the software is scanning the storage medium, however, the rate at which other processes (e.g., user applications) are able to access data from files stored on the storage medium is substantially reduced. In the context of a hard drive, for example, the rate at which data is accessible (e.g., by a word processor application) may be five to ten times slower when the disk is being scanned by anti-malware software.

As a consequence, users are, at the very least, inconvenienced by the slow file access times, and worse, some users may elect to abort pestware scanning when they want to launch an application or open files so they do not have to wait as long for the application or files to be accessed. Accordingly, current software is not always able to scan and remove pestware in a convenient manner and will most certainly not be satisfactory in the future.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one embodiment, the invention may be characterized as a method for scanning files for the presence of pestware. In this embodiment, the method includes retrieving information from a storage device with a first process so as to enable the information to be analyzed for a presence of pestware. In response to another process attempting to access the storage device while the first process is retrieving information, the first process ceases to retrieve the information from the storage device during an initial interrupt period. In this embodiment, the method includes extending the initial interrupt period in response to detecting one or more other attempts by one or more other processes to access the storage device so as to create an extended interrupt period. The method in this embodiment also includes resuming, after the first process has ceased to retrieve the information for a desired time period, the retrieval of information from the storage device with the first process even if one or more other processes attempt to access the storage device.

In another embodiment, the invention may be characterized as a method for managing access to a storage device of a computer. In this embodiment the method includes allowing an anti-pestware process to access a storage device of the computer, identifying at least one other process attempting to access the storage device while the anti-pestware process is accessing the storage device of the protected computer, ceasing to allow the anti-pestware process to access the storage device during an interrupt period in response to the at least one other process attempting to access the storage device. In this embodiment the method includes limiting the interrupt period so as to allow the anti-pestware process to access the storage device of the computer even if the at least one process continue to attempt to access the storage device.

In yet another embodiment, the invention may be characterized as a system for managing pestware. In this embodiment, an anti-pestware application is configured to access a file storage device on the protected computer and to identify pestware on the protected computer. In addition, a filter driver is configured to monitor attempts, by at least one process unassociated with the anti-pestware application, to access the file storage device and to prevent the anti-pestware application from accessing the file storage device during an interrupt period in response to the at least one process attempting to access the file storage device. These and other embodiments are described in more detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings where like or similar elements are designated with identical reference numerals throughout the several views and wherein:

FIG. 1 illustrates a block diagram of a protected computer in accordance with one implementation of the present invention;

FIG. 2 is a flowchart of one method for managing access to a storage device such as the storage device depicted in FIG. 1;

FIG. 3 is a timing diagram in accordance with one potential media-access management scheme such as may be implemented in connection with the embodiment depicted in FIG. 1;

FIG. 4 is a timing diagram in accordance with another potential media-access management scheme such as may be implemented in connection with the embodiment depicted in FIG. 1; and

FIG. 5 is a timing diagram in accordance with yet another potential disk management scheme such as may be implemented in connection with the embodiment depicted in FIG. 1.

### DETAILED DESCRIPTION

According to several embodiments, the present invention manages access to a file storage device on a protected computer so as to reduce the file-access delays that typically occur when an anti-pestware application is accessing the storage device.

In prior art computer systems, when two processes (e.g., an anti-pestware scanning application and a user application) are attempting to obtain data from files stored on a file storage device of a computer, the computer's operating system attempts to provide both processes access to the storage device. In the context of disk drive storage devices, when the processes are retrieving data from a disk drive, the disk drive must move its head from one disk location to another disk location on a frequent basis to seek the file information desired by each process.

In many disk drives, the time associated with each seek for data is approximately 7 milliseconds—about the time it takes for the drive to provide 250 kilobytes of data to a single process. As a consequence, in these types of disk drives, when only one process is being served data, the single process might be served up to 40 megabytes of data per second, but when two process are served data, each process may be served only 4 megabytes of data per second.

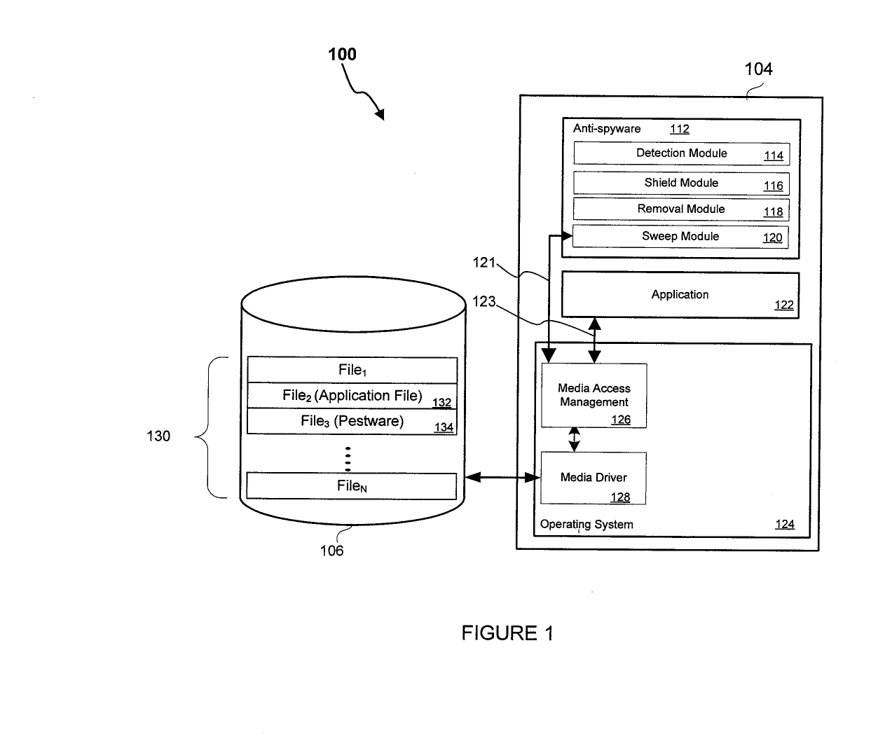

Referring first to FIG. 1, shown is a block diagram 100 of a protected computer/system in accordance with one implementation of the present invention. The term “protected computer” is used herein to refer to any type of computer system, including personal computers, handheld computers, servers, firewalls, etc. This implementation includes memory 104 (e.g., random access memory (RAM)), and residing in memory are shown an anti-spyware application 112, another application 122 and an operating system 124.

As shown, the anti-spyware application includes 112 a detection module 114, a shield module 116, a removal module 118 and a sweep module 120, which are implemented in software and are executed from the memory 104 by a processor (not shown). The software 112 can be configured to operate on personal computers (e.g., handheld, notebook or desktop), servers or any device capable of processing instructions embodied in executable code. Moreover, one of ordinary skill in the art will recognize that alternative embodiments, which implement one or more components (e.g., the anti-spyware 112) in hardware, are well within the scope of the present invention.

In several embodiments, the sweep module 120 is responsible for accessing and retrieving information from the N files 130 located on the storage device 106, and the detection module 114, it is responsible for detecting pestware or pestware activity on the protected computer 100 based upon the information received from the N files 130.

As shown, the storage device 106 provides storage for a collection of N files 130, which includes an application file 132 and a pestware file 134. The storage device 106 is described herein in several implementations as hard disk drive for convenience, but this is certainly not required, and one of ordinary skill in the art will recognize that other storage media may be utilized without departing from the scope of the present invention. In addition, one of ordinary skill in the art will recognize that the storage device 106, which is depicted for convenience as a single storage device, may be realized by multiple (e.g., distributed) storage devices.

As depicted in FIG. 1, the application file 132 in this embodiment is a file that the application 122 is attempting to access utilizing a call 123 to the operating system 124. The application 122 may be any type of process that requests access to the storage device 106. In some embodiments, for example, the application may be a user application such as a word processor, spreadsheet or email application, but this is certainly not required. Moreover, the application 122 is depicted as running in memory merely for purposes of describing various aspects of the present invention, but there need not be an application residing in memory at all. For example, several embodiments of the present invention are applicable to manage access to the storage device 106 when a user is attempting to initially launch the application 122.

The operating system 124 in the exemplary embodiment is not limited to any particular type of operating system and may be operating systems provided by Microsoft Corp. under the trade name WINDOWS (e.g., WINDOWS 2000, WINDOWS XP, and WINDOWS NT). Additionally, the operating system may be an open source operating system such operating systems distributed under the LINUX trade name. For convenience, however, embodiments of the present invention are generally described herein with relation to WINDOWS-based systems. Those of skill in the art can easily adapt these implementations for other types of operating systems or computer systems.

Also shown in FIG. 1 are an access management module 126 and a storage device driver 128. In the exemplary embodiment, the access management module 126 monitors attempts (e.g., by the application 122 and/or the anti-spyware module 112) to access the storage device 106, and as discussed further herein, manages (e.g., at least in part), access to the storage device 106. In several embodiments, the access management module 126 is realized as a filter driver. The storage device driver 128 is a driver with functions that enable communication with the file storage device 106, and in several embodiments is realized as a hard-drive device driver.

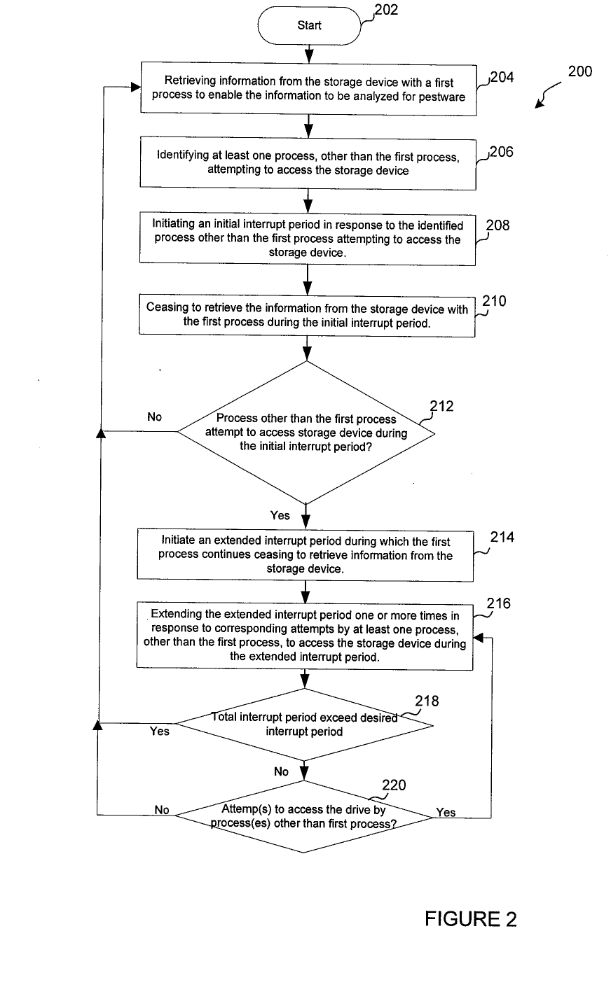

While referring to FIG. 1, simultaneous reference will be made to FIG. 2, which depicts a method for managing access to the file storage device 106 in accordance with an exemplary embodiment. As shown in FIG. 2, while a first process (e.g., a process associated with the sweep module 120) is accessing the storage device 106 (e.g., to retrieve information to be analyzed for a presence of pestware) (Block 202, 204), the access management module 126 identifies attempts by one or more other processes (e.g., a process associated with the application 122) to access the storage device 106 (Block 206). In response to another process attempting to access the storage device 106, an initial interrupt period is initiated (Block 208), and during the initial interrupt period, the first process (e.g., a process associated with the sweep module 120) ceases to access the storage device 106 (Block 210).

In some embodiments the media access management is carried out by the access management module 126 in connection with the anti-spyware application 112. In one embodiment for example, the access management module 126 informs the anti-spyware application 126 that another process is attempting to access the storage device 106, and in response, the anti-spyware application 112 then ceases to access the storage device 106.

In other embodiments, the access management module 126 simply blocks attempts by the anti-spyware application 112 to access the storage device during the initial interrupt period and subsequent extensions to the interrupt period. In this way, any delays associated with communicating instructions from the access management module 126 to the anti-spyware application 112 are avoided.

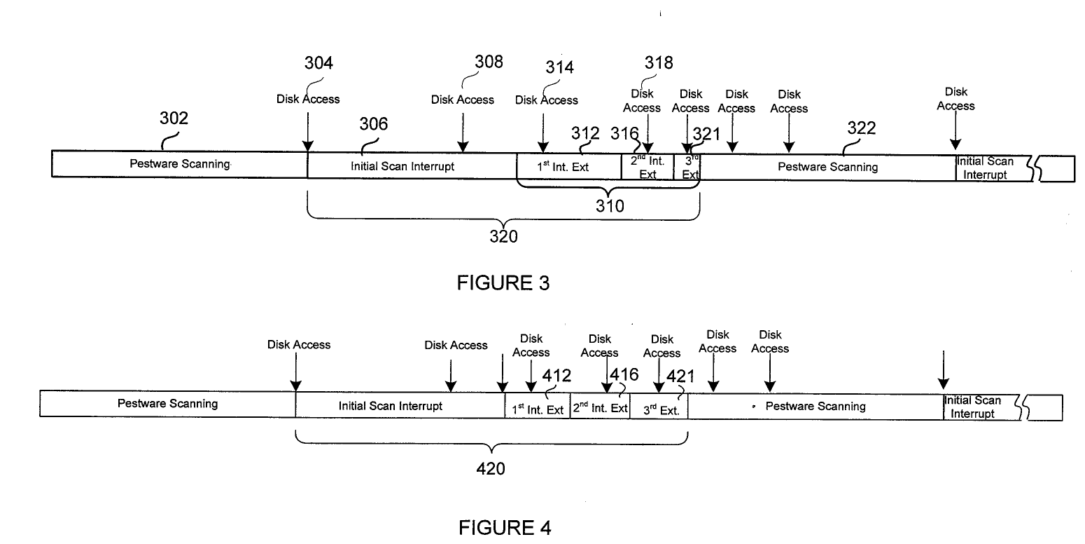

Referring briefly to FIG. 3 for example, shown is a timing diagram in accordance with one potential disk management scheme implemented in connection with the embodiment depicted in FIG. 1. As shown in FIG. 3, the sweep module 120 initially accesses the storage device 106 during a first time period 302 until the application 122 attempts to access 304 the storage device 106. Once the application 122 attempts to access the disk storage device 106, an initial scan interrupt period 306 begins in which the sweep module 120 ceases to access the storage device 106. In this way, the application 122 is able to launch or retrieve information at a much higher rate than if the operating system 124 serviced both the sweep module 120 and the application 122 simultaneously.

Referring back to FIG. 2, if no process other than the first process (e.g., other than a process associated with the sweep module 120) attempts to access the disk storage device 106 during the initial interrupt period 306, then the initial interrupt period 306 expires and the first process (e.g., a process associated with the sweep module 120) then again accesses the storage device (e.g., to scan information on the storage device 106 for the presence of pestware), and the steps discussed with reference to Blocks 204-210 are carried out again.

If a process does attempt to access the storage device 106 during the initial interrupt period (Block 212), then an extended interrupt period is initiated during which time the first process (e.g., a process associated with the sweep module 120) continues to cease accessing the storage device 106. In some embodiments, the extended interrupt period is only initiated when the process attempting to access the storage device 106 during the initial interrupt period is the same process that first triggered the initial interrupt period. In other embodiments, however, when any process (except the first process) attempts to access the storage device 106, the initial interrupt period is extended so that the first process does not access the storage device 106.

Referring again to the exemplary access management scheme depicted in FIG. 3, when a process associated with the application 122 attempts to access 308 the storage device 106 during the initial interrupt period 306, an extended interrupt period 310 first begins with a first interrupt extension 312. Although not depicted in FIG. 3, if there are no attempts (by processes other than processes associated with the anti-spyware application 112) to access the storage device 106 during the first extension 312, then the sweep module 120 is again able accesses the storage device 106. As shown in FIG. 3, in some embodiments, the first interrupt extension 312 is half as long as the initial interrupt period 306, but this is certainly not required, and as discussed further herein other extension lengths may be utilized as well.

Referring again to FIG. 2, after an extended interrupt period (e.g., the extended interrupt period 310) is initiated, it is extended one or more times in response to corresponding attempts by process(es) other than the first process to access the storage device (Block 216). For example, FIG. 3 depicts a situation where the extended interrupt period 310 was extended two times after the interrupt extension 312 in response to a process attempting to access 314 the storage device 106 during the first interrupt extension 312 (triggering a second interrupt extension 316) and a process attempting to access 318 the storage device 106 during the second interrupt extension 316.

Referring again to FIG. 2, at least one limit is placed on the length of the extended interrupt period so as to limit a total interrupt period to a desirable length of time. As shown in FIG. 2, if the total interrupt period exceeds the desired amount of time (e.g., a desired maximum amount of time) the interrupt period is ended and the first process is again able to access the storage device 106 (Blocks 218, 204). In this way, the first process (e.g., a process associated with the anti-spyware application 112) is able to carry out its intended function (e.g., scanning for pestware) even if one or more other processes continue to attempt to access the storage device 106.

If, however, the total interrupt period is still within a desirable length of time, and a process attempts to access the storage device 106, then the extended interrupt period is again extended one or more times in response to corresponding attempts by a process(es) to access the storage device (Blocks 218, 220, 216).

In several embodiments, once the interrupt period (e.g., the total interrupt period 320) has ended, then the first process is able to access the storage device 106 for a period of time (e.g., 1-3 seconds) without being interrupted again. In some embodiments for example, the operating system operates in a typical fashion—allowing the first process to access the storage device while also allowing other processes (e.g., a process of the application 122) to access the drive.

Referring again to FIG. 3, for example, the total interrupt period 320 is limited in duration to enable the sweep module 120 to resume scanning and continue to scan the storage device 106 for a predetermined period of time 322 even if other processes attempt to access the storage device.

In the exemplary embodiment depicted in FIG. 3, the total interrupt period 320 is limited by reducing the length of each extension period 312, 316, 321 after the initial interrupt period 306 until a minimum time extension (i.e., the third extension 321) is reached. In the embodiment depicted in FIG. 3, each successive extension 312, 316, 321 in the total interrupt period 320 has a duration that is one-half of the duration of the previous interrupt period. It should be recognized that three extension periods beyond the initial extension period is merely exemplary and that there may be fewer or more extension periods.

In other embodiments, a total interrupt period is limited by simply establishing a maximum amount of time and or maximum number of extensions. As shown in FIG. 4, for example, depicted is another timing diagram in accordance with another potential media access scheme in which each extension period 412, 416, 421 has the same time duration. In this embodiment, the total interrupt period 420 is limited by a predetermined maximum amount of time so as to enable the sweep module 120 to again access the storage device.

As shown in the embodiments depicted in FIGS. 3 and 4, in some embodiments, each extension period 312, 316, 321, 412, 416, 421 is measured from an end of a previous interrupt period, but this is certainly not required, and in other embodiments, one or more interrupt extension period begins from a time when there is an attempt by a process, other than the first process (e.g., a process associated with the anti-spyware application 112) to access the storage device.

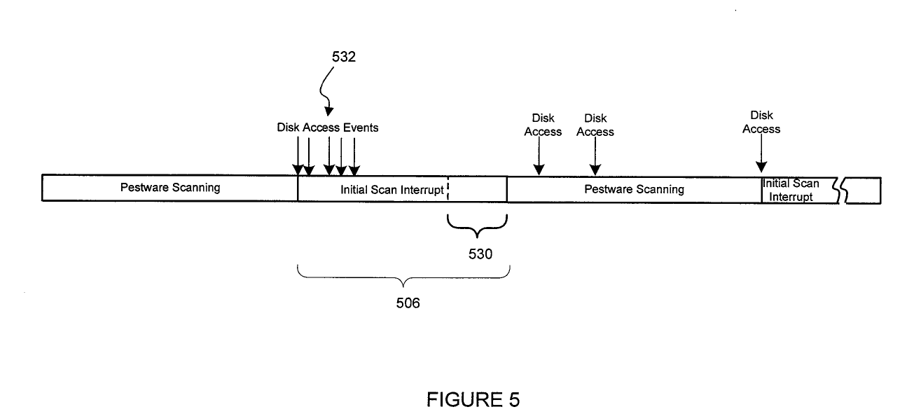

It is also contemplated that many variations of the disclosed process of initiating and extending an interrupt period may be implemented without departing from the scope of the present invention. As depicted in FIG. 5, for example, an initial interrupt period 506 is not extended unless there is an attempt to access the storage device 106 during a later portion 530 of the initial interrupt period 506.

As shown in FIG. 5, although there are several attempts 532 to access the storage device 106 by one or more processes other than a sweep module 120 during an early portion of the initial scan interrupt period 506, the initial interrupt period 506 is not extended because no attempts to access the storage device 106 were made during the later portion 530 of the initial interrupt period 506. It is contemplated that the size of the later portion 530 may be from around 25% to 50% of the initial interrupt period 530, but this is certainly not required and one of ordinary skill in the art will recognize that the size of the later portion 530 relative to the initial interrupt period 506 may vary depending upon the desired operating characteristics.

It should be recognized that the media access schemes discussed with reference to FIGS. 3, 4 and 5 are shown in separate drawings merely for clarity, and that aspects of each of the embodiments described with reference to these drawings may be combined. For example, the diminishing periods of the interrupt extensions described with reference to FIG. 3 may be combined with the aspects, as discussed with reference to FIG. 5, of extending an initial interrupt period only when there is an attempt to access the storage media 106 during a later portion of the initial interrupt period. In conclusion, the present invention provides, among other things, a system and method for managing access to file storage media. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for scanning files on a protected computer for pestware comprising:
retrieving information from a storage device with a first process so as to enable the information to be analyzed for a presence of pestware;
identifying at least one process, other than the first process, attempting to access the storage device while the first process is retrieving information;
ceasing to retrieve the information from the storage device with the first process for an initial interrupt period in response to the at least one process other than the first process attempting to access the storage device;
detecting an attempt by the at least one process other than the first process to access the storage device during the initial interrupt period;
extending, in response to detecting the attempt by the at least one process to access the storage device, the initial interrupt period by a first extension so as to create an extended interrupt period, wherein the first process continues to cease retrieving information from the storage device during the extended interrupt period; and
resuming, after the first process has ceased to retrieve the information for a desired time period, the retrieval of information from the storage device with the first process even if the at least one process other than the first process attempts to access the storage device, so as to enable analysis of information on the storage device to continue.

2. The method of claim 1 wherein the identifying includes identifying the at least one process with a filter driver.

3. The method of claim 1 wherein the identifying includes identifying the at least one process by injecting a DLL in the at least one process that detects when the at least one process is attempting to access the storage device.

4. The method of claim 1 wherein the detecting the attempt by the at least one process includes detecting the same process attempting to access the storage device during the initial interrupt period that was attempting to access the storage device while the first process was retrieving information.

5. The method of claim 1, wherein the detecting the attempt by the at least one process includes detecting a different process attempting to access the storage device during the initial interrupt period than the at least one process that was attempting to access the storage device while the first process was retrieving information.

6. The method of claim 1, including:
detecting another attempt by the at least one process other than the first process to access the storage device during the extended interrupt period; and
extending the extended interrupt period by a second extension in response to detecting the other attempt to access the storage device during the extended interrupt period.

7. The method of claim 6, wherein the second extension is less than the first extension.

8. The method of claim 7 including extending the extended interrupt period by a series of extensions that decrease in magnitude until a minimum extension is reached, each of the extensions being in response to a corresponding one of a series of attempts to access the storage device by the at least one process other than the first process.

9. The method of claim 1 wherein the storage device is a storage device selected from the group consisting of a disk drive, non-volatile memory, a tape drive and an optical drive.

10. A method for managing access to a storage device of a computer comprising:
allowing an anti-pestware process to access a storage device of the computer;
identifying at least one process, other than the anti-pestware process, attempting to access the storage device while the anti-pestware process is accessing the storage device of the protected computer;
ceasing to allow the anti-pestware process to access the storage device during an interrupt period in response to the at least one process other than the first process attempting to access the storage device, wherein the interrupt period is limited so as to allow the anti-pestware process to access the storage device of the computer even if the at least one process continue to attempt to access the storage device.

11. The method of claim 10, including:
detecting an attempt by the at least one process other than the anti-pestware process to access the storage device during the initial interrupt period;
extending, in response to detecting the attempt by the at least one process to access the storage device, the initial interrupt period by a first extension so as to create an extended interrupt period, wherein the anti-pestware process continues to cease retrieving information from the storage device during the extended interrupt period.

11. The method of claim 10 wherein the identifying includes identifying the at least one process with a filter driver.

12. The method of claim 10 wherein the identifying includes identifying the at least one process by injecting a DLL in the at least one process that detects when the at least one process is attempting to access the storage device.

13. The method of claim 10 wherein the allowing the anti-pestware process to access the storage device includes allowing the anti-pestware process to retrieve information from files stored in the computer so as to assess whether the files include a pestware file, and wherein the ceasing to allow the anti-pestware process includes ceasing to allow the pestware from accessing the information from the files.

14. The method of claim 1 wherein the storage device is a storage device selected from the group consisting of a disk drive, non-volatile memory, a tape drive and an optical drive.

15. A system for managing pestware on a protected computer including:
an anti-pestware application configured to access a file storage device on the protected computer and to identify pestware on the protected computer; and
a filter driver configured to monitor attempts, by at least one process unassociated with the anti-pestware application, to access the file storage device and to prevent the anti-pestware application from accessing the file storage device during an interrupt period in response to the at least one process attempting to access the file storage device.

16. The system of claim 15 wherein the anti-pestware application includes:
a scanning module configured to scan a file storage device so as to retrieve information from files stored on the file storage device; and
a pestware detection module configured to analyze the retrieved information so as to identify whether the files include pestware files.

17. The system of claim 15, wherein the filter driver is configured to prevent the anti-pestware application from accessing the file storage device by sending an instruction to the anti-pestware application to cease accessing the storage device.

18. The system of claim 15, wherein the filter driver is configured to prevent the anti-pestware application from accessing the file storage device by blocking access to the storage device.

19. The system of claim 15, wherein the filter driver is configured to identify the at least one process unassociated with the anti-pestware application and prevent the anti-pestware application from accessing the file storage device in response to the at least one process unassociated with the anti-pestware application being a particular type of process.

20. The system of claim 15, wherein the storage device is a storage device selected from the group consisting of a disk drive, non-volatile memory, a tape drive and an optical drive.

21. The system of claim 15 wherein the filter driver is configured to:
detect an attempt by the at least one process other than the anti-pestware application to access the storage device during the interrupt period; and
extend, in response to detecting the attempt by the at least one process to access the storage device, the interrupt period by a first extension so as to create an extended interrupt period, wherein the filter driver continues to prevent the anti-pestware application from accessing the file storage device during the extended interrupt period.
